(19) United States
(12) Patent Application Publication
(10) Pub. No.: US 2006/0254856 A1
(43) Pub. Date: Nov. 16, 2006

(54) Ladder base anchoring device

(76) Inventors: Scott Kuniewich, (US); Christine Chang, Waltham, MA (US)

Correspondence Address: Christine Chang, 15 Dix Street, Waltham, MA, 02453, US

(21) Appl. No.: 11/128,113

(22) Filed: May 12, 2005

(51) Int. Cl. E06C 7/42

(52) U.S. Cl. 182/107; 182/108

(57) ABSTRACT

A ladder anchoring device that consists of a horizontal board and a vertical member and the vertical member is welded to the horizontal board to form a T-shaped object. When hammering the device into the ground, the vertical member will be partially underneath the ground while the ladder leans against the horizontal board to provide stability.

### BACKGROUND OF THE INVENTION

1. Field of Invention

This invention relates to a device that secures a upright inclined ladder leaning against a structure. More particularly, the invention relates to a device that can be anchored into penetrable or non-solid surfaces preventing the base of the ladder from sliding or inadvertent movement thereof.

When using a ladder to access the inaccessible location, the ladder may slide from the original position and move laterally, either side-by-side or away-inwards from the accessing location due to the user's movement on the ladder. Such movement of the ladder may cause the ladder to move from the accessing location or fall onto the ground and cause injuries or catastrophic consequences to the user, bystanders, or the surrounding properties.

2. Description of Prior Art

The existing ladder base security systems that prevent the ladder from inadvertent movements can be divided mostly into systems with anchoring and systems without anchoring. The systems without an anchoring device often requires non-skid high friction pads, bases or shoes to be positioned on a surface such as depicted in U.S. Pat. Nos. 6,745,870, 6,655,497, and 4,648,482. The pads or bases of the non-anchoring system not only need to rest on a leveled surface, they often require a hard and smooth supporting surface. These types of systems do not provide for secured anchoring of the ladders.

U.S. Pat. No. 2,523,535 issued in 1950 to Warrant Little disclosed an adjustable ladder anchor comprises two elements telescopically engage one another where the first element provides a S-shaped end that is to be hooked onto the rung of the ladder and the second element has a mean to accept a stake-like member to anchor the ladder to the ground. Although the Little's anchoring system does prevent the ladder from sliding away from the structure against which it is leaning, the system is not only restricted to ladders with circular shaped rungs, it does not prevent the ladders from sliding side-by-side. Further, the extended length of the rod creates safety hazard as the user and the bystanders may trip over it.

U.S. Pat. No. 4,576,250 issued in 1986 to Robert Marish disclosed ladder stops to be used as anchors adjacent to the feet of the ladder for preventing the ladder from sliding away from a structure against which it was leaning. Marish's ladder stops comprise a pair of U-shaped brackets and a pair of vertical anchoring member where the U shape brackets embrace the ladder feet, one to each foot, and the vertical anchoring members are inserted into the ground. Although the Marish's ladder stops provide an anchoring system that secures the lower portion of the ladder and prevent the ladder from moving in all directions, the U-shaped bracket creates a limitation as it can only be used on ladders with the width of the feet smaller than the space provided by the U-shaped bracket. The system further limits itself to be made of metal material. In addition, the bendable U-shaped brackets are welded to the anchoring member in a way that after numerous usages, the welded area may be weaken and eventually cause the U-shape brackets to fall of the anchoring members.

U.S. Pat. Nos. 5,337,856 issued in 1994 to James Fillers discloses ladder anchoring pins that includes a U-shaped member to be engaged on and across the lowest rung of the ladder while the lower portion of the anchoring pin is inserted into the ground. Fillers's anchoring pin provides a safer device than the Little's adjustable ladder anchor because it does not have an extended rod that may cause safety hazards. However, Filler's anchoring pin does not provide a complete side-by-side stability even though two anchoring pins can be placed at the opposite sides of the lowest rung to prevent lateral and side-by-side displacement. Even with two anchoring pins, because they rest on the rung, there are still room for the pins to slide side-by-side and eventually causing the ladder to lose its side-by-side stability.

U.S. Pat. Nos. 6,089,350 issued in 2000 to Eddie Hankins discloses a device for anchoring an upright inclined ladder to prevent movement of the ladder away from an object. What distinguishes the present invention from the '350 patent is that the present invention does not provide support by hooking around the rung. This provides flexibility because rungs can come in different sizes and shapes. Further, '350 limits that the support device be hooked onto the lowest rung where there present invention does not have such restrictions.

None of the above inventions, taken either individually or in combination describes the invention hereof claimed. A L-shaped horizontal member corners the corners of the ladder is not seen in the prior art. The L-shaped horizontal member provides sufficient surface allowing easy hammering when the anchoring device is hammered into the ground. Further more, the L-shape design allows the anchoring device to be independent of the size or the shape of the ladder feet as well as the rung. These features are not seen in the prior art.

3. Objects and Advantages

One of the objects of the invention is to provide a simple, durable and affordable device that effectively prevents the ladder from inadvertent movements in all directions. First, the invention does not require any assembly; the device consists of two welded components: a horizontal board and a vertical anchoring member. Second, since the two components are welded, it does not involve loose parts and the one piece device provides durability. Third, the device can be made in materials other than metal as long as the horizontal board is strong enough to handle the pressure from the hammer, the vertical anchoring member is strong enough to penetrate the ground, and the entire device is strong enough to support the weight of the ladder.

The device will be manufactured with material sufficient enough to support the weight of the ladder plus the user on the ladder. It can be made of metal material such as aluminum and steal.

The device is also designed to be compatible with ladders that have either angular or circular legs and that have either angular or circular rungs. The compatibility allows the device to be used with a wide variety of ladders that are already on the market without requirement any modification of the ladders.

Most of all, the object of the invention is to provide security to the ladder users and to prevent the ladder base from sliding in all directions. The vertical anchoring member prevents the ladders from sliding in all directions. The horizontal board can be used prevent the ladders from sliding away or towards the structure to which it was leaned on or from moving side-by-side that could cause the ladder to fall off completely of the leaning structure.

### SUMMARY OF THE INVENTION

In accordance with the present invention a ladder base anchoring system comprising a horizontal board and a vertical anchoring member and the vertical anchoring member is welded perpendicularly to the center bottom of the horizontal board forming a T shaped object. At least one ladder base stabilizers apparatus is hammered into the ground in which the ladder can lean on it to provide stability and security.

The said horizontal board is generally a rectangular shape; however it is not limited to designs with shapes other than a rectangular shape. One corner of said horizontal board can be cut to form an opening generally to a 90 degree angle so that when the anchoring system is secured to the ladder leg, the opening is wide enough so the one corner of the ladder leg can lean against the opening.

The vertical member points downwards while securing the anchoring system to the ladder leg. At least one anchoring system is needed to provide substantial support and prevent the ladder from movement. After securing, a hammer is used to hammer the T shape object into the ground.

### A BRIEF DESCRIPTION OF THE DRAWINGS

FIG. 1 is an embodiment view where two anchoring devices are anchored into the ground and the horizontal L-shaped members corner the outer corners of the ladder legs

FIG. 2 is an embodiment view where a single anchoring device is anchored into the ground and the horizontal L-shaped member corners one of the outer corners of the ladder legs.

FIG. 3 depicts that the anchoring device wherein the vertical side of the ladder has a circular shape

FIG. 4 depicts that the anchoring device is placed from the back outer corner of the ladder leg.

### DETAILED DESCRIPTION OF THE PREFERRED EMBODIMENT

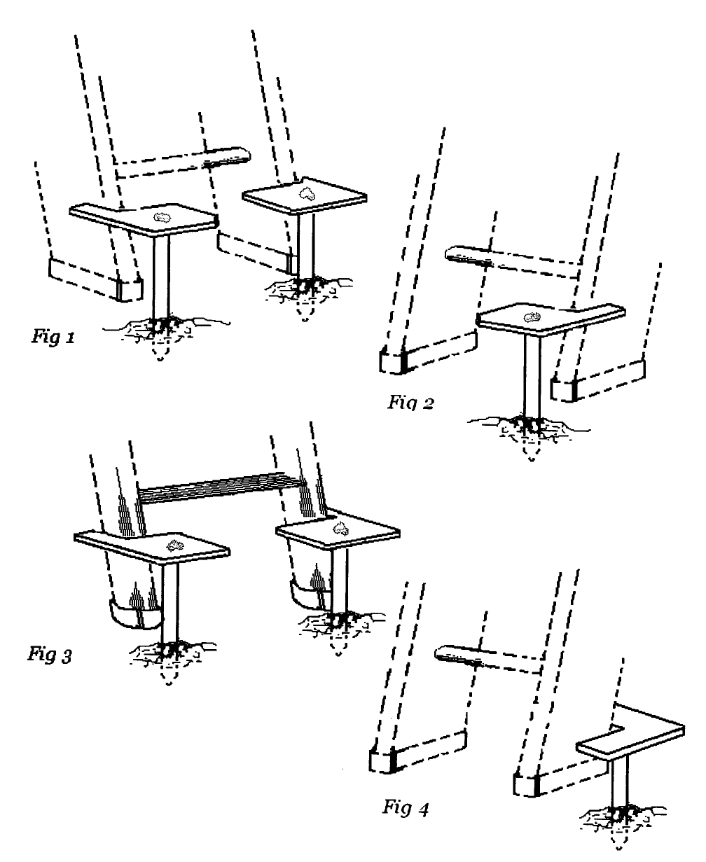

The invention is the most useful when using with an extension ladder. Comparing to other types of ladder, such as the folding or the step-type ladder, an extension ladder is more susceptible to inadvertent movements causing by the user on the ladder. Shown in FIG. 1 is a ladder with anchoring device at the lower portion of the ladder. The preferred embodiment is to place at least two anchoring device with the horizontal L-shaped bracket mirroring each other at the lower portion of the ladder on the opposite side of the structure of which it was leaning. A hammer is used to anchor the anchoring device by hitting on the top of the T shape object shown in FIG. 1.

FIG. 2 shows that stability and security can also be provided by using merely one anchoring device.

Although the preferred shape of the ladder leg is angular, the device can also be used on circular ladder legs so long the opening of the horizontal board is sufficiently wide to embrace the ladder leg to provide sufficient support.

The anchoring system can also be place behind the ladder on the side of the structure to which it was leaning, as depicted in FIG. 4. If the anchoring system is used in this embodiment, the system will not prevent the ladder from sliding away from the structure to which it was leaning but it will prevent the ladder from sliding side by side. This embodiment can be used when there are objects such as rocks under the ground on the outer side of the ladder that prevents the anchoring system from penetrating the ground.

What is claimed is:

1. A ladder base anchoring device for securing the ladder from movements comprises of at least one apparatus that has
a. A horizontal rectangular board and
b. A vertical anchoring member that is welded to the bottom of the said horizontal rectangular board on the bottom side of the said horizontal rectangular board.

2. The said horizontal rectangular board in claim 1 has one of its corners cut to forms a L-shape board and the corner that is been cut forms generally a 90 degree angle.

3. The said vertical anchoring member in claim 1 is welded to the center of the bottom of the said horizontal rectangular board perpendicularly to form a T-shape object.

4. The said ladder base anchoring device in claim 1 is made of material sufficiently to support the weight of the ladder and the user on the ladder and to prevent the inadvertent movement of the ladder.
